(19) United States
(12) Patent Application Publication
(10) Pub. No.: US 2001/0042048 A1
(43) Pub. Date: Nov. 15, 2001

(54) Method and apparatus for electronically distributing audio recordings

(75) Inventors: Patrick O. Boykin, Los Angeles, CA (US); Vwani P. Roychowdhury, Los Angeles, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: The Regents of the University of California

(21) Appl. No.: 09/858,587

(22) Filed: May 15, 2001

Related U.S. Application Data
(60) Provisional application No. 60/204,216, filed on May 15, 2000.

(51) Int. Cl. G06F 12/14; H04L 9/00

(52) U.S. Cl. 705/51; 713/201

(57) ABSTRACT

A method, apparatus, and article of manufacture for electronically distributing an audio recording, other media, or software. An audio player obtains an audio file that comprises an encrypted audio recording. Without an appropriate key for the audio file, the audio player may only play the audio recording in a reduced first quality. However, with the appropriate key, the audio player may play the audio recording in a second quality. The user purchases and the audio player receives the appropriate key to unlock the high quality aspects of the audio file. Additionally, an identifier for the user is written into the modified audio file to associate the audio file with a particular user. Such an association enables the system to track distribution of the particular audio file and may enable the award of points or credit to the user for such distribution.

### CROSS-REFERENCE TO RELATED APPLICATIONS

This application claims the benefit under 35 U.S.C. Section 119(e) of the following co-pending and commonly-assigned U.S. provisional patent application, which is incorporated by reference herein:

Provisional Application Serial No. 60/204,216, filed May 15, 2000, by Patrick O. Boykin et al., entitled “BUSINESS METHOD FOR ONLINE MUSIC DISTRIBUTION,” attorneys' docket number 30435.91-US-P1.

### BACKGROUND OF THE INVENTION

1. Field of the Invention

The present invention relates generally to music distribution, and in particular, to a method, apparatus, and article of manufacture for electronically distributing music while enforcing the intellectual property rights of the distributed music.

2. Description of the Related Art

With the availability of broadband and high speed access increasing, the use of the Internet has proliferated. With such proliferation, high bandwidth connections ate often used to transfer files that would take an unacceptably long time to download with a traditional low bandwidth connection (e.g., a 24.4 Kb modem connection). Such files include audio recordings (e.g., digital music), video, word processing documents, applications, etc.

More particularly, the Internet has been widely used to disseminate and download audio recordings in a variety of formats. The moving pictures expert group (MPEG) audio layer 3 format (commonly referred to as the MP3 format) for digital music has become the default standard for digital music on the Internet.

The explosive use and downloading of MP3 files has been at the expense of the content providers as the vast majority of MP3 files are unlicensed copies. For example, some Internet companies may give away MP3 files for free, with the hope that compact disc (CD) sales will follow. Other online distributors may sell MP3 files at a price of 99 cents each to the consumer to be downloaded from their Web site. Further uses of the MP3 files include giving away a file to promote an artist or allowing all tracks on a CD to be sampled in real time using a player that is configured to play audio or clips of audio.

The drawback to this model is that, since the files are distributed as MP3 files, there is no technological barrier to users trading them with friends and giving them away. For example users may pull raw audio data from a music CD, encode it into the MP3 format (referred to as “ripping”), and then distribute the MP3 file to friends, family, acquaintances or may store the MP3 file on a Web or FTP (file transfer protocol) site and provide access to anyone. In another example, users may load software (e.g., Napster or Gnutella) wherein users freely exchange MP3 files with each other.

Accordingly, pirate Web and FTP (file transfer protocol) sites have proliferated, and trading pirated music on IRC (Internet Relay Chat) channels, distributing pirated music through binary groups on Usenet, and more recently dedicated applications that allow the free exchange of MP3 files, has become the norm.

Schemes have been suggested and are currently being developed to curb the trend. For example, entire music files may be encrypted and sold to individual users. Such encryption may prevent piracy because only the intended user can play the song. The danger of such a system is two-fold: (1) users may reject it (as was done with DIVX [digital video express] video discs), or (2) the encryption technology could be compromised (as was done with digital video discs [PVD]).

### SUMMARY OF THE INVENTION

A successful music/audio recording distribution system is a system that provides the consumer with a desired product, and protects the interests of the creative community. In addition to satisfying these advantages, one or more embodiments of the invention also provide users with the incentive to play by the rules and the ability to utilize common Internet practices (such as trading audio recording files with friends) in a manner in which copyrights ate still respected.

Users are allowed to download radio quality music. This music may be stored or traded with friends. The files may comprise any format (e.g., MP3), but are encoded to provide varying levels of quality. The technology of the present invention allows the higher quality aspects of the music to be locked away until purchased. Once a user purchases the rights to a file, the user may play the higher quality music. The copies the user gives to friends may only have radio quality, but once the friend purchases, the original purchaser receives points. In this way, users are encouraged to distribute legal files and not pirated files. The points a user accumulates could potentially be redeemable for cash, for credit towards free music, to concert tickets, to fan merchandise, or any system of rewards that encourages the user to play by the rules.

In addition to being utilized in connection with audio recordings, one or more embodiments of the invention may also be used to provide varying levels of quality for video, photographs, or any other type of media.

### BRIEF DESCRIPTION OF THE DRAWINGS

Referring now to the drawings in which like reference numbers represent corresponding parts throughout:

FIG. 1 schematically illustrates a hardware and software environment in accordance with one or more embodiments of the invention; and

FIG. 2 is a flow chart illustrating the electronic distribution of audio recordings in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention. Overview

One or more embodiments of the invention provide for the distribution across a network (e.g., the Internet) of digital audio recordings (e.g., MP3 files). An audio recording is encoded into a modified audio file such that an appropriate key is required to listen to the audio recording in an optimal quality (e.g., high fidelity). Without the appropriate key, the audio recording may only be listed to at a reduced quality (e.g., low fidelity).

The key is associated with each audio file and may identify a particular user/consumer. When a user desires to purchase/unlock the higher quality audio recording, the purchase information (including a user identifier from the audio file) is transmitted to the server where a key (and potentially the user identification) is obtained and forwarded to the user. The key may then be written into the audio file to track the distribution of the file.

Since the user identification is transmitted to the server at the time of purchase, the server can maintain statistics on where a file originated from. The user identified in the transmission may also earn credit towards a reward that may be claimed. Such a reward system encourages the distribution and purchase of music legally from a Web site provider (which may ensure that the appropriate parties are compensated).

### Hardware Environment

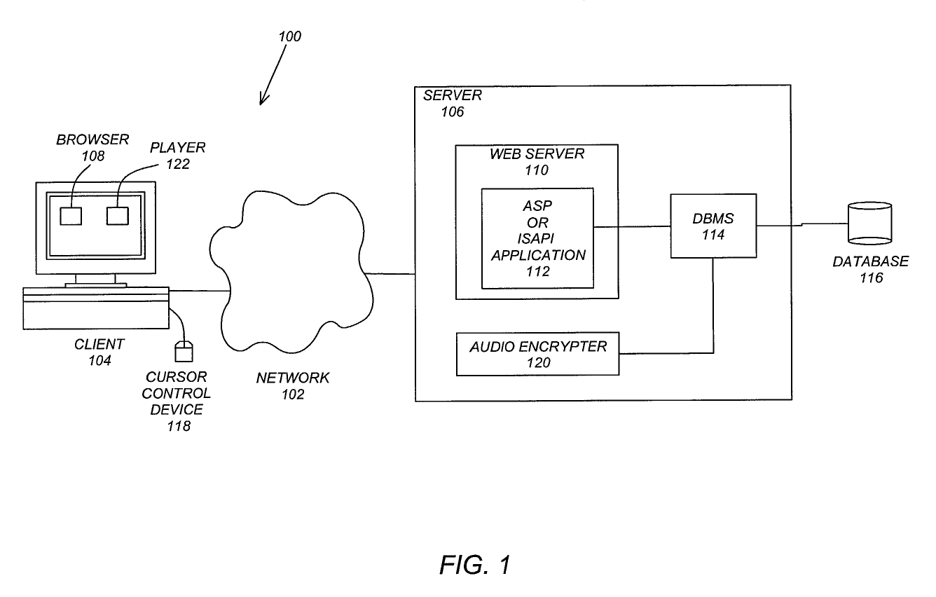

FIG. 1 schematically illustrates a hardware and software environment in accordance with one or more embodiments of the invention, and more particularly, illustrates a typical distributed computer system 100 using a network 102 to connect client computers 104 to server computers 106. A typical combination of resources may include a network 102 comprising the Internet, LANs (local area networks), WANs (wide area networks), or the like, clients 104 that are personal computers or workstations, and servers 106 that are personal computers, workstations, minicomputers, or mainframes. Additionally, both client 104 and server 106 may receive input (e.g., cursor location input) and display a cursor in response to an input device such as cursor control device 118.

A network 102 such as the Internet connects clients 104 to server computers 106. Clients 104 may execute a client application, Web browser 108, or audio player 122, and communicate with server computers 106 executing Web servers 110 and/or audio encrypter 120. Such a Web browser 108 is typically a program such as Netscape Navigator or Microsoft Internet Explorer. Further, the software executing on clients 104 may be downloaded from server computer 106 to client computers 104 and installed as a plug in or ActiveX control of a Web browser 108. Accordingly, player 122 may be configured as a plug in or ActiveX control of browser 108.

The Web server 110 is typically a program such as Microsoft's Internet Information Server and may host an Active Server Page (ASP) or Internet Server Application Programming Interface (ISAPI) application 112, which may interface with and be used to manipulate data in database 116 through a database management system (DBMS) 114. Alternatively, database 116 may be part of or connected directly to client 104 instead of communicating/obtaining the information from database 116 across network 102. Web server 110 may also be utilized to create and provide e-commerce services such as selling and maintaining keys and tags for modified audio files. Such a web server 110 or application may interact with both DBMS 114 and audio encrypter 120.

Audio encrypter 120 is configured to encrypt/encode a digital audio recording or MP3 file into a modified audio file. Such a modified audio file may provide two or more levels of quality, each of which are accessible depending on the access privileges of a client 104. Once audio encrypter 120 creates a modified audio file, the audio encrypter 120 may manipulate and store the audio file in database 116 through DBMS 114.

Generally, these components 108-118 all comprise logic and/or data that is embodied in or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Thus, embodiments of the invention may be implemented as a method, apparatus, or article of manufacture using standard programming and/or engineering techniques to produce software, firmware, hardware, or any combination thereof The term “article of manufacture” (or alternatively, “computer program product”) as used herein is intended to encompass logic and/or data accessible from any computer-readable device, carrier, or media.

Those skilled in the art will recognize many modifications may be made to this exemplary environment without departing from the scope of the present invention. For example, those skilled in the art will recognize that any combination of the above components, or any number of different components, including different logic, data, different peripherals, and different devices, may be used to implement the present invention, so long as similar functions are performed thereby.

### Software Embodiments

Audio encrypter 120 is configured to obtain a digital audio recording and encrypt the recording to provide varying levels of quality that are accessible depending on access privileges of a client 104 or user. As described herein, the encryption techniques ate preferably utilized to encrypt/encode a digital recording. Further, such encryption techniques may encrypt an already encrypted recording, a compressed recording (e.g., an MP3), or a non-compressed recording. Audio encrypter 120 partially locks or encrypts an audio recording or audio file to produce a modified or encrypted audio file. Without an appropriately supplied key, access is restricted to lower quality aspects of the encrypted audio file.

Audio encrypter 120 may encode two or more levels of quality. For example, the audio recording may be encoded to provide access to a low fidelity, medium fidelity, or high fidelity recording depending on the access privileges of the user. Alternatively, only two quality levels may be available (e.g., low fidelity and high fidelity).

The use of MP3 files can be used to illustrate the modification of an audio file in accordance with in the invention. An MP3 file may be modified by audio encrypter 120 to create a RF-MP3, or restricted fidelity MP3. Such a RF-MP3 file may only be used by player 122 to play the audio recording in quality that is sub-par (e.g., restricted or low fidelity) without an appropriate key. However, when an appropriate key is provided, the modified MP3 file may be used by player 122 to play the audio recording in a standard quality or differing quality (e.g., high fidelity).

The appropriate key for each file may be unique to each downloaded file and may be stored in database 116 with a corresponding key identification (key id). Thus, a table or list in database 116 may contain the filename and the appropriate key (and/or key id) for that file. A user on client 104 may purchase the appropriate key from a content provider, e-commerce center, etc. For example, as described above, ASP 112 may provide e-commerce services for the sale of the keys stored in database 116 to client 104. Such e-commerce services may be on the same server 106 or a separate server 106 from other services utilized in accordance with the invention.

Once purchased, server 106 (e.g., through an e-commerce service) supplies the key to the audio player 122 on client 104. Upon receiving the appropriate key, audio player 104 may enable the playback of higher quality audio. Additionally, audio player 122 is configured to write/encode the user's identification (id) (and/or key id) into the audio file. Such encoding does not permanently unlock the file. Instead, such encoding provides a method to associate a particular file with a particular user. Accordingly, the key may be associated with a user's/purchaser's id wherein both the key and user id may be stored in the audio file. Alternatively, only the user's id may be stored within the audio file.

To enable the tracking of the encoded file on a per-user basis, the table in database 116 may also contain a reference to the user for each key that is issued for a file (e.g., key 1223—Jon Doe, key 1224—Jane Smith, etc.). Alternatively, a table of keys that each user has purchased may be maintained (e.g., Jon Doe—keys 1223, 1256, 3443; Jane Smith—keys 1224, 4567, 8452, etc.).

Since a purchaser's identification is associated and written to a file, distribution of a particular copy of the file may be tracked. The user/purchaser may freely distribute the modified file. Since the file remains in an encrypted form, all copies of the distributed file may only be played back in the reduced quality format. If a second user elects to purchase high quality playback, the original purchaser's id from the file is forwarded to the server 106 (e.g., e-commerce services on server 106). The server 106 can then determine where the file originated from. Once the second user purchases a key, the new user id and/or key id is written by the second user's player 122 to the file.

Based on the original user id submitted with the purchase information, any tables maintained by server 106 (e.g., in database 116) may be updated and the history of the file distribution may be tracked. Accordingly, server 106 may maintain statistics on the distribution chain for a file. Further, to provide incentive for distributing the modified/encrypted audio file instead of the non-encrypted audio file, original purchasers may be awarded points or credit when a subsequent user purchases a new key. Such points/credit may then be redeemed for future purchases, cash, gift certificates, coupons, or any other type of tangible or intangible asset.

In one or more embodiments of the invention, player 122 supports a one-button purchase system. In such an embodiment, the user's payment information (such as credit card or another form) is collected upon the first purchase. The purchase information may be stored on client 104 or remotely on server 106. Subsequently, whenever an audio recording is played or a key purchase is ordered, a single button click by the user may allow the user to purchase the appropriate key for the selected file.

One or more embodiments of the invention provide the ability to appropriately manage the set of keys (referred to as the key ring) a user has and to ensure that the key ring is not easily shared with other users. Various methods for key management may be implemented. An encrypted key ring may be stored by the secure player 122 on the client 104. In such an approach, a user's id, password, and a list of keys is stored on client 104. Since a user will likely prefer not to have his/her password (which would allow anyone to purchase music with one click and charge it to the original user's account), the user is discouraged from giving the file away, as it would potentially allow other users access to the user's keys.

Alternatively, the key ring may be stored remotely on a secure server 106 (e.g., within database 116). In such an embodiment, each time the user elects to play an audio recording, the key is sent by a secure connection (e.g., HTTPS—secure hypertext transfer protocol, virtual private network tunnel, etc.) to the player 122. Thereafter, instead of writing the access key to disk locally on client 104, the key is never written to disk. Such a model may provide portability for the user (with his password and audio files, he can access his keys anywhere on any player) and more security.

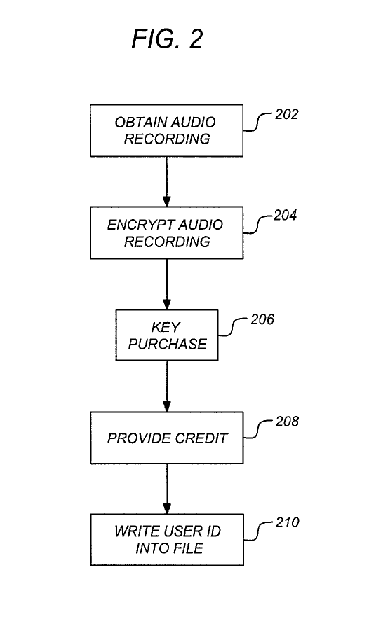

FIG. 2 is a flow chart illustrating the electronic distribution of audio recordings in accordance with one or more embodiments of the invention. At step 202, an audio recording is obtained. At step 204, the audio recording is encrypted into an audio file wherein access is restricted to a reduced first quality (e.g., low fidelity) without an appropriate key. However, with the appropriate key, an audio player may play the audio recording in a second quality (e.g., high fidelity).

At step 206, the appropriate key is purchased by a user from server 106 (e.g., through server 106 provided e-commerce services). Such a purchase may be enabled by a single-user action wherein the purchase information is stored on client 104 or server 106. If stored on the client, the single-action of the user provides for transmitting the purchase information from the client 104 to the server 106. If stored on the server, the single-user action provides for using the already stored information. Once purchased, the appropriate key is transmitted to the player 122. Further, the appropriate key may be stored and maintained in a key ring on the client 104 or on server 106 (along with the user id in some embodiments).

With the purchase information, the user identification (for the prior purchaser of the appropriate key) stored within the audio file is transmitted to the server 106. At step 208, the user identified by the user identification receives (or is provided with) credit or points that may be redeemed for a reward. Such credit may be maintained by DBMS 114 in a table within database 116. Once player 122 receives the key, the user id for the new purchaser is written to the file at step 210. By writing the new purchaser's id into the file, the file is associated with the user such that future purchasers of the file will permit the purchaser to receive credit.

In summary, the present invention comprises a method of distribution of digital music. In an incentive-based system of one or more embodiments of the invention, the system allows users to freely distribute and trade music while encouraging compliance with relevant intellectual property laws (i.e., copyright aspects). Such a system allows free listening for low fidelity recordings while requiring the user to purchase a high fidelity recording that may only be used by the person that made the purchase. Users are encouraged to purchase a recording and then distribute a file by awarding points to the user for future purchases by other users.

### Conclusion

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention. Further, since the system provides for encoding a user's identification (or an identifier that may be used to identify the user) into an audio file by the player 122, one or more embodiments of the invention provide the ability to control a player 122. Nonetheless, the detailed design of such a secure player 122 is peripheral to this invention, and the invention may use any secure player 122, now known or developed in the future.

In addition to utilizing the invention for audio recordings, a similar system may be developed for other types of media such as video clips, photographs, etc. Additionally, software may be distributed in a similar manner. In such embodiments, the media/software is encrypted to provide for lower quality or restricted use without an appropriate key. Higher quality playback and/or use are permitted upon the purchase of the appropriate key. Further, the user identification is encoded within the media/software file to allow tracking of the file and award points/credit to the purchaser.

In summary, one or more embodiments of the invention provide a method for distributing digital music online that addresses concerns of both content providers (e.g., major record companies) and the customers. In particular, the method addresses security, portability and accessibility, and rights management. With regard to security, the method aims to keep the source/original digital content from being accessed by sophisticated users, and pirated on the Internet for anonymous and free use. With regard to portability and accessibility, a customer is able to conveniently purchase music online and is able to listen to it multiple times, and if desired, using different players. With regard to rights management, the method provides a business framework where customers are provided with incentives to remain honest and play according to the generally accepted rules of doing fair Internet commerce.

The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for electronically distributing an audio recording comprising:
(a) obtaining, in an audio player, an audio file that comprises an encrypted audio recording, wherein:
(i) without an appropriate key for the audio file, the audio player is configured to play the audio recording in a reduced first quality; and
(ii) with the appropriate key, the audio player is configured to play the audio recording in a second quality;
(b) receiving, in the audio player, the appropriate key;
(c) in response to receiving the appropriate key, writing a user identifier into the modified audio file to associate the audio file with a particular user.

2. The method of claim 1 wherein the audio file is a moving pictures experts group audio layer 3 (MP3) file.

3. The method of claim 1 further comprising storing the appropriate key in a database on a user's computer.

4. The method of claim 1 wherein the appropriate key is stored in a database on a server.

5. The method of claim 4 further comprising
transmitting, to a server, a request to play the audio recording; and
in response to the request, receiving the appropriate key from the server.

6. The method of claim 1 wherein the received appropriate key comprises an identifier for the audio file and an associated user identifier.

7. The method of claim 1 further comprising transmitting, to a server, purchase information to purchase the appropriate key, wherein the appropriate key is received in response to the transmitting.

8. The method of claim 7 wherein:
the purchase information comprises a user identification of a prior user that last purchased the appropriate key for the audio file; and
credit is assigned to the prior user.

9. The method of claim 8 wherein the credit is redeemed for a reward.

10. The method of claim 7 wherein the purchase information comprises payment information that is stored such that a future purchase of an audio file is conducted by a single user action.

11. A computer-implemented method for electronically distributing an audio recording comprising:
(a) obtaining an audio recording;
(b) encrypting the audio recording to create an audio file wherein the audio recording is capable of being played by an audio player in a reduced first quality without an appropriate key;
(c) transmitting the audio file;
(d) receiving a request to play the audio recording in a second quality from a particular user; and
(e) in response to the request, transmitting the appropriate key for the audio file that enables the audio player to play the audio recording in a second quality wherein the appropriate key is used to identify the particular user, and wherein the key is capable of being written in the audio file.

12. The method of claim 11 wherein the audio file is a moving pictures experts group audio layer 3 (MP3) file.

13. The method of claim 11 wherein the appropriate key is stored in a database on the particular user's computer.

14. The method of claim 11 wherein the appropriate key is stored in a database on a server.

15. The method of claim 11 wherein the request to play the audio recording comprises purchase information for purchasing the appropriate key.

16. The method of claim 15 wherein:
the purchase information comprises a user identification of a prior user that last purchased the appropriate key for the audio file; and
credit is assigned to the prior user.

17. The method of claim 16 wherein the credit is redeemed for a reward.

18. The method of claim 15 wherein the purchase information comprises payment information that is stored such that a future purchase of an audio file is conducted by a single user action.

19. A system for electronically distributing an audio recording comprising:
(a) an audio recording;
(b) an audio file comprising an encrypted version of the audio recording;
(c) an audio player configured to:
(i) play the audio recording in a reduced first quality when an appropriate key for the audio file is not provided;
(ii) play the audio recording in a second quality when the appropriate key for the audio file is provided;
(iii) receive the appropriate key for the audio file,
(iv) write a user identifier into the modified audio file to associate the audio file with a particular user.

20. The system of claim 19 wherein the audio file is a moving pictures experts group audio layer 3 (MP3) file.

21. The system of claim 19 further comprising a database on a user's computer configured to store the appropriate key.

22. The system of claim 19 wherein the appropriate key is stored in a database on a server.

23. The system of claim 22 wherein the audio player is further configured to:
transmit, to a server, a request to play the audio recording; and
in response to the request, receive the appropriate key from the server.

24. The system of claim 19 wherein the received appropriate key comprises an identifier for the audio file and an associated user identifier.

25. The system of claim 19, wherein the audio player is further configured to transmit, to a server, purchase information to purchase the appropriate key, and wherein the appropriate key is received in response to the transmitting.

26. The system of claim 25 wherein:
the purchase information comprises a user identification of a prior user that last purchased the appropriate key for the audio file; and
credit is assigned to the prior user.

27. The system of claim 26 wherein the credit is redeemed for a reward.

28. The system of claim 25 wherein the purchase information comprises payment information that is stored such that a future purchase of an audio file is conducted by a single user action.

29. A system for electronically distributing an audio recording comprising:
(a) an audio recording;
(b) an audio file comprising an encrypted version of the audio recording;
(c) a computer server configured to:
(i) obtain the audio recording;
(ii) encrypt the audio recording to create the audio file wherein the audio recording is capable of being played by an audio player in a reduced first quality without an appropriate key;
(iii) transmit the audio file;
(iv) receive a request to play the audio recording in a second quality from a particular user; and
(v) in response to the request, transmit the appropriate key for the audio file that enables the audio player to play the audio recording in a second quality wherein the appropriate key is used to identify the particular user, and
wherein the key is capable of being written in the audio file.

30. The system of claim 29 wherein the audio file is a moving pictures experts group audio layer 3 (MP3) file.

31. The system of claim 29 wherein the appropriate key is stored in a database on the particular user's computer.

32. The system of claim 29 further comprising a database on the server, wherein the database is configured to store the appropriate key.

33. The system of claim 29 wherein the request to play the audio recording comprises purchase information for purchasing the appropriate key.

34. The system of claim 33 wherein:
the purchase information comprises a user identification of a prior user that last purchased the appropriate key for the audio file; and
credit is assigned to the prior user.

35. The system of claim 34 wherein the credit is redeemed for a reward.

36. The system of claim 33 wherein the server is further configured to store the purchase information such that a future purchase of an audio file is conducted by a single user action.

37. An article of manufacture comprising a program storage medium readable by a computer and embodying one or more instructions executable by the computer to perform a method for electronically distributing an audio recording, the method comprising:
(a) obtaining, in an audio player, an audio file that comprises an encrypted audio recording, wherein:
(i) without an appropriate key for the audio file, the audio player is configured to play the audio recording in a reduced first quality; and
(ii) with the appropriate key, the audio player is configured to play the audio recording in a second quality;
(b) receiving, in the audio player, the appropriate key;
(c) in response to receiving the appropriate key, writing a user identifier into the modified audio file to associate the audio file with a particular user.

38. The article of manufacture of claim 37 wherein the audio file is a moving pictures experts group audio layer 3 (MP3) file.

39. The method of claim 37, the method further comprising storing the appropriate key in a database on a user's computer.

40. The article of manufacture of claim 37, wherein the appropriate key is stored in a database on a server.

41. The article of manufacture of claim 40, the method further comprising
transmitting, to a server, a request to play the audio recording; and
in response to the request, receiving the appropriate key from the server.

42. The article of manufacture of claim 37 wherein the received appropriate key comprises an identifier for the audio file and an associated user identifier.

43. The article of manufacture of claim 37, the method further comprising transmitting, to a server, purchase information to purchase the appropriate key, wherein the appropriate key is received in response to the transmitting.

44. The article of manufacture of claim 43 wherein:
the purchase information comprises a user identification of a prior user that last purchased the appropriate key for the audio file; and
credit is assigned to the prior user.

45. The article of manufacture of claim 44 wherein the credit is redeemed for a reward.

46. The article of manufacture of claim 43 wherein the purchase information comprises payment information that is stored such that a future purchase of an audio file is conducted by a single user action.

47. An article of manufacture comprising a program storage medium readable by a computer and embodying one or more instructions executable by the computer to perform a method for electronically distributing an audio recording, the method comprising:
(a) obtaining an audio recording;
(b) encrypting the audio recording to create an audio file wherein the audio recording is capable of being played by an audio player in a reduced first quality without an appropriate key;
(c) transmitting the audio file;
(d) receiving a request to play the audio recording in a second quality from a particular user; and
(e) in response to the request, transmitting the appropriate key for the audio file that enables the audio player to play the audio recording in a second quality wherein the appropriate key can be used to identify the particular user, and wherein the key is capable of being written in the audio file.

48. The article of manufacture of claim 47 wherein the audio file is a moving pictures experts group audio layer 3 (MP3) file.

49. The article of manufacture of claim 47 wherein the appropriate key is stored in a database on the particular user's computer.

50. The article of manufacture of claim 47, the method further comprising storing the appropriate key in a database on a server.

51. The article of manufacture of claim 47 wherein the request to play the audio recording comprises purchase information for purchasing the appropriate key.

52. The article of manufacture of claim 51 wherein:
the purchase information comprises a user identification of a prior user that last purchased the appropriate key for the audio file; and
credit is assigned to the prior user.

53. The article of manufacture of claim 52 wherein the credit is redeemed for a reward.

54. The article of manufacture of claim 51 wherein the purchase information comprises payment information that is stored such that a future purchase of an audio file is conducted by a single user action.
